(19) United States
(12) Patent Application Publication
(10) Pub. No.: US 2021/0115249 A1
(43) Pub. Date: Apr. 22, 2021

(54) ANNEALED THERMOPLASTIC MATERIALS

(71) Applicant: Covestro LLC, Pittsburgh, PA (US)

(72) Inventors: Liang Chen, Sewickley, PA (US); Karen L. Stewart, Pittsburgh, PA (US); Bruce D. Lawrey, Seattle, WA (US)

(21) Appl. No.: 16/890,569

(22) Filed: Jun. 2, 2020

Related U.S. Application Data
(60) Provisional application No. 62/924,341, filed on Oct. 22, 2019.

(51) Int. Cl. C08L 75/04; C08J 3/24

(52) U.S. Cl. CPC C08L 75/04; B33Y 70/00; C08J 3/247

(57) ABSTRACT

A thermoplastic material can include a thermoplastic polyurethane material having a hard segment content of at least 30 wt % based on a total weight of the thermoplastic polyurethane material. The thermoplastic polyurethane material is pre-annealed to have a single melting peak having a full-width at half maximum value of less than or equal to 15° C. based on a differential scanning calorimetry analysis from −25° C. to 250° C. at a 20° C./min temperature ramp.

### PRIORITY

This application claims the benefit of U.S. Provisional Application Ser. No. 62/924,341, filed Oct. 22, 2019, which is incorporated herein by reference.

### BACKGROUND

Additive manufacturing generally involves building a three-dimensional (3D) object in a layer-by-layer manner. A variety of additive manufacturing techniques can be employed to build a 3D object using a layer-by-layer approach. Non-limiting examples can include photopolymerization techniques, powder bed fusion techniques, material extrusion techniques, jetting techniques, and direct energy deposition techniques, for example. Photopolymerization techniques generally employ a photopolymer resin that is selectively solidified when exposed to electromagnetic radiation. Powder bed fusion techniques generally include depositing a layer of powder material that is selectively fused together, such as via thermal fusion. Material extrusion techniques generally involve selectively extruding material through a nozzle to a build platform or build material in a layer-by-layer manner. Jetting techniques generally involve jetting or printing build materials and/or binders in a selective manner to form a 3D object. Direct energy deposition techniques generally involve melting powder material as it is deposited to a build platform or build material.

### BRIEF DESCRIPTION OF THE DRAWINGS

Various features and characteristics of the examples described in this specification may be better understood by reference to the accompanying FIGURE, in which:

FIG. 1 presents differential scanning calorimetry data for an example thermoplastic polyurethane annealed at various conditions.

### DESCRIPTION OF EMBODIMENTS

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this written description, the singular forms “a,” “an” and “the” include express support for plural referents unless the context clearly dictates otherwise. Thus, for example, reference to “a polymer” or “the polymer” can include a plurality of such polymers.

In this application, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” in this written description it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 milligrams to about 80 milligrams” should also be understood to provide support for the range of “50 milligrams to 80 milligrams.” Furthermore, it is to be understood that in this specification support for actual numerical values is provided even when the term “about” is used therewith. For example, the recitation of “about” 30 should be construed as not only providing support for values a little above and a little below 30, but also for the actual numerical value of 30 as well. Unless otherwise specified, all numerical parameters are to be understood as being prefaced and modified in all instances by the term “about,” in which the numerical parameters possess the inherent variability characteristic of the underlying measurement techniques used to determine the numerical value of the parameter.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “1 to 5” should be interpreted to include not only the explicitly recited values of 1 to 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### EXAMPLE EMBODIMENTS

A variety of thermoplastic materials can be suitable for additive manufacturing processes. In some cases, it is believed that a material having a sharp or narrow melting temperature and sharp or narrow recrystallization temperature can be valuable for a variety of additive manufacturing techniques. For example, a narrow melting temperature and recrystallization temperature can define a relatively clear thermal processing window to effectively thermally fuse build material together as it is deposited in a layer-by-layer manner. This can minimize the likelihood of exposing the build material to either insufficient or excessive temperatures and associated adverse effects. Further, defining a clear processing window can also assist in optimizing equipment parameters during printing, such as build chamber temperature, sintering energy requirements, etc.

However, some thermoplastic materials do not necessarily have a narrow melting temperature, but may still have properties that can be desirable for one or more additive manufacturing processes. This can present a variety of processing challenges, such as unknown or unpredictable thermal processing windows and difficulties in establishing effective equipment parameters for suitably printing a 3D part, for example. As such, a variety of thermoplastic materials are described herein that are thermally modified to have a narrow melting temperature, which, in some cases, can make the disclosed thermoplastic materials more suitable or desirable for some additive manufacturing processes than prior to or without the thermal modification. More specifically, a variety of thermoplastic materials typically having a broad melting temperature, or otherwise poorly defined melting temperature, can be thermally modified to have a narrower or more defined melting temperature.

In further detail, in some examples, a thermoplastic material having a broad or otherwise poorly defined melting temperature can be thermally modified or annealed to form an annealed thermoplastic material having a comparatively narrower and more defined melting temperature. As used herein, “annealed” and “annealing” generally refer to a process of thermally modifying a thermoplastic material to tune one or more thermal properties of the material, such as melting temperature, melting enthalpy, or the like, for example. Without wishing to be bound by theory, it is believed that thermoplastic polyurethane materials, for example, can have a broad range of crystalline structures, which can result in an observed broad melting temperature. “Annealing” the thermoplastic polyurethane materials within the observed broad melting range is believed to melt small crystalline structures and induce the formation of a more uniform crystalline phase comprised mainly of hard segments of the thermoplastic polyurethane material. Thus, “annealing” can thermally modify the thermoplastic polyurethane material to have one or more tuned or otherwise adjusted thermal properties that can be more desirable for some additive manufacturing techniques as compared to the corresponding non-annealed thermoplastic polyurethane material (i.e., the thermoplastic polyurethane material prior to being annealed). For example, in some cases, the “annealing” process described herein can provide a thermoplastic polyurethane material with a narrow melting peak, which can render the material more suitable for a variety of additive manufacturing techniques than the corresponding non-annealed thermoplastic polyurethane material. As used herein, “non-annealed” or “corresponding non-annealed” material refers to the thermoplastic material prior to undergoing an annealing process as described herein. It is further noted that “annealing” as described herein is distinct from typical drying and staging processes. For example, drying is typically performed at a temperature and time period suitable to reduce the moisture content of the additive manufacturing build material or thermoplastic resin, but is otherwise inadequate to achieve the higher degree of melting and agglomeration associated with “annealing” as described herein. Similarly, staging is typically performed at a temperature and time period suitable for moisture control and to remove fine particles from the additive manufacturing build material or resin, but is otherwise inadequate to achieve the higher degree of melting and agglomeration of “annealing” as described herein.

In some specific examples, the thermoplastic material can include a thermoplastic polyurethane material. In further detail, the thermoplastic polyurethane material can generally have a medium to high hard segment content. For example, in some cases the thermoplastic polyurethane material can have a hard segment content of at least 30 wt % based on a total weight of the thermoplastic polyurethane material. Additionally, the thermoplastic polyurethane material can have a soft segment content of at least 5 wt % based on a total weight of the thermoplastic polyurethane material. In some additional examples, the thermoplastic polyurethane material can have a hard segment content from 30 wt % to 80 wt % based on a total weight of the thermoplastic polyurethane material. In other examples, the thermoplastic polyurethane material can have a hard segment content of from 30 wt % to 50 wt %, from 40 wt % to 60 wt %, from 50 wt % to 70 wt %, or from 60 wt % to 80 wt % based on a total weight of the thermoplastic polyurethane material.

In some additional examples, the thermoplastic polyurethane material can include a reaction product of a polyisocyanate, a chain extender, and a soft segment component having functional groups that are reactive toward isocyanate groups. The polyisocyanate and the chain extender define the hard segment of the thermoplastic polyurethane material.

The polyisocyanate employed in the thermoplastic polyurethane material can be any polyisocyanate that reacts to produce a non-amorphous thermoplastic polyurethane material. Non-limiting examples of suitable polyisocyanates can include aliphatic diisocyanates, cycloaliphatic diisocyanates, aromatic diisocyantes, or a combination thereof. Aliphatic diisocyanates can include tetramethylene 1,4-diisocyanate, pentamethylene 1,5-diisocyanate, hexamethylene 1,6-diisocyanate, dodecane 1,12-diisocyanate, the like, or a combination thereof. Aromatic diisocyanates can include diphenylmethane 4,4′-diisocyanate, the like or a combination thereof. In some specific examples, the polyisocyanate can be an aromatic polyisocyanate.

A variety of chain extenders can also be employed in the thermoplastic polyurethane material. Chain extenders can include a variety of isocyanate-reactive groups, such as hydroxyl groups, carboxyl groups, amine groups, mercaptan groups, the like, or a combination thereof. In some further examples, the chain extenders can have from two to three (e.g., two or three) isocyanate-reactive groups. In some examples, the chain extenders can have from 1.8 to 3.0 Zerewitinoff-active hydrogen atoms. In some additional examples, the chain extenders can have a number average molecular weight of from 60 g/mol to 450 g/mol. Non-limiting examples of chain extenders can include aliphatic diols having from 2 to 14 carbon atoms (e.g., ethanediol, 1,2-propanediol, 1,3-propanediol, 1,4-butanediol, 2,3-butanediol, 1,5-pentanediol, 1,6-hexanediol, diethylene glycol, dipropylene glycol), diesters of terephthalic acid with glycols having from 2 to 4 carbon atoms (e.g. bis(ethylene glycol) terephthalate or bis-1,4-butanediol terephthalate), hydroxyalkylene ethers of hydroquinone (e.g. 1,4-di(b-hydroxyethyl)hydroquinone) ethoxylated bisphenols (e.g. 1,4-di(b-hydroxyethyl)bisphenol A), (cyclo)aliphatic diamines (e.g., isophoronediamine, ethylenediamine, 1,2-propylenediamine, 1,3-propylenediamine, N-methylpropylene-1,3-diamine, N,N′-dimethylethylenediamine), aromatic diamines (e.g., 2,4-toluenediamine, 2,6-toluenediamine, 3,5-diethyl-2,4-toluenediamine, 3,5-diethyl-2,6-toluenediamine), primary monoalkyl-, dialkyl-, trialkyl-, or tetraalkyl-substituted 4,4′-diaminodiphenylmethanes, the like, or a combination thereof. While not required, in some examples the chain extender can be or include an alkane diol (e.g., ethanediol, 1,2-propanediol, 1,3-propanediol, 1,4-butanediol, 2,3-butanediol, 1,5-pentanediol, 1,6-hexanediol, the like, or a combination thereof).

The soft segment component is not particularly limited and can include a variety of components having functional groups that are reactive toward isocyanate groups (e.g., hydroxyl groups, carboxyl groups, amine groups, mercaptan groups, isocyanate groups, the like, or a combination thereof). For example, any suitable polyol can be employed in the thermoplastic polyurethane material. Non-limiting examples of suitable polyols can include polyether polyols, polyester polyols, polycarbonate polyols, polysiloxane polyols, the like, or a combination thereof.

In some examples, the combination of hard segment components and soft segment components can provide a thermoplastic polyurethane material having a shore hardness of from 80 A to 80D based on ASTM D2240-15. In some specific examples, the combination of hard segment components and soft segment components can provide a thermoplastic polyurethane material having a shore hardness of from 80 A to 95 A, from 85 A to 100 A, from 30D to 45D, from 50D to 65D, from 55D to 70D, or from 65D to 80D based on ASTM D2240-15.

In some specific examples, the thermoplastic polyurethane material can have a weight average molecular weight (Mw) of from 30 kilogram per mol (kg/mol) to 200 kg/mol based on gel permeation chromatography. In still additional examples, the thermoplastic polyurethane material can have an Mw of from 30 kg/mol to 70 kg/mol, from 50 kg/mol to 90 kg/mol, from 70 kg/mol to 110 kg/mol, from 90 kg/mol to 130 kg/mol, from 110 kg/mol to 150 kg/mol, from 130 kg/mol to 170 kg/mol, from 150 kg/mol to 180 kg/mol, or from 175 kg/mol to 200 kg/mol based on gel permeation chromatography.

Depending on the particular thermoplastic polyurethane employed, a variety of annealing temperatures (i.e. temperature at which the thermoplastic polyurethane is annealed) and annealing times (i.e. time period during which the thermoplastic polyurethane is annealed) can be employed to produce the annealed thermoplastic polyurethane material. More specifically, different annealing temperatures and annealing times can be employed for different species of thermoplastic polyurethane materials, depending on the molecular weight, hard segment content, hardness, etc. of a respective thermoplastic polyurethane material.

Thus, in some examples, the annealing temperature and annealing time for a particular thermoplastic polyurethane material can be determined using a differential scanning calorimetry (DSC) analysis of the thermoplastic polyurethane material prior to annealing. A variety of parameters can be employed to obtain a DSC profile of the material to determine a suitable annealing temperature. In some examples, the DSC parameters can include a temperature ramp rate of from 5° C./min to 40° C./min over a suitable temperature range. In some additional examples, temperature ramp rates can be from 5° C./min to 25° C./min or from 15° C./min to 35° C./min. The temperature range evaluated in the DSC analysis can vary depending on the particular thermoplastic polyurethane being evaluated. As a general rule, the lower limit of the temperature range can be a temperature that is less than a temperature where hard segment melting begins, which permits detection of hard segment melting characteristics. In some additional examples, the lower limit can be sufficiently low to also characterize soft segment components as well. Additionally, the upper limit of the temperature range can be a temperature that is high enough to melt hard segment components, but low enough so as to not degrade the material. In some specific examples, the DSC analysis can be performed over a temperature range of from −25° C. to 250° C. at a heating and cooling rate of 20° C./min. Of course, other suitable DSC parameters can be employed as necessary or desirable.

As previously described, the DSC profile (e.g., based on graph or plot obtained from a DSC analysis) for a particular thermoplastic polyurethane material can be used to determine an appropriate annealing temperature for a particular thermoplastic polyurethane material. For example, the annealing temperature can be based on one or more of a main melting peak and a highest melting peak of the DSC profile. By “main melting peak,” it is meant the melting peak with the greatest enthalpy in a DSC profile having multiple melting peaks, or the sole melting peak of a DSC profile having a single melting peak. By “highest melting peak,” it is meant the melting peak at the highest temperature in a DSC profile having multiple melting peaks. In some examples, the highest melting peak can exclude very small peaks that show up in the DSC profile, such as peaks that are less than 5% of the area of the main melting peak. Thus, in some cases, the highest melting peak can be a peak having an area that is at least 5%, at least 10%, at least 20%, at least 30%, at least 40%, at least 50%, at least 60%, or at least 70% of the area of the main melting peak. Where the DSC profile has only a single melting peak, then the highest melting peak equals the main melting peak. With this in mind, in some cases, the annealing temperature can be a temperature of from 40° C. less than the temperature of the main melting peak of the non-annealed thermoplastic polyurethane material to 5° C. greater than the temperature of the highest melting peak of the non-annealed thermoplastic polyurethane material. In other examples, the annealing temperature can be a temperature of from 30° C. less than the temperature of the main melting peak of the non-annealed thermoplastic polyurethane material to a temperature of the highest melting peak of the non-annealed thermoplastic polyurethane material.

In another example, the annealing temperature and annealing time can be based on another data point that is collectable using DSC. Specifically, a sample of the thermoplastic polyurethane material can be analyzed via DSC to determine the percentage of the hard segment or crystalline segment of the thermoplastic polyurethane that is melted at a given temperature. The annealing temperature can be selected to be a temperature at which from 10% to 90%, or from 25% to 85%, of the crystalline segment is melted based on a DSC analysis. In some additional examples, the annealing temperature can be selected to be a temperature at which from 25% to 45%, from 35% to 55%, from 45% to 65%, from 55% to 75%, or from 65% to 85% of the crystalline segment is melted based on a DSC analysis. In some examples, it can be beneficial to only melt a portion of the hard segment or crystalline segment of the thermoplastic polyurethane material to avoid complete agglomeration of the thermoplastic polyurethane material. It is further noted that complete melting of the thermoplastic polyurethane material can erase the thermal effects of the annealing process. Thus, the annealing temperature can be determined using one or more of the methods described above to melt only a portion of the hard segment of the thermoplastic polyurethane.

The annealing time can be somewhat variable depending on the particular thermoplastic polyurethane material being annealed. In some examples, the annealing time can be from about 10 minutes to about 24 hours. In some further examples, the annealing time can be from about 30 minutes to about 5 hours, from about 4 hours to about 10 hours, from about 8 hours to about 15 hours, from about 12 hours to about 18 hours, or from about 15 hours to about 24 hours.

Thus, a variety of annealing temperatures and annealing times can be employed to produce the annealed thermoplastic polyurethane material. It is further noted that the melting temperature of the annealed thermoplastic polyurethane material can be at least partially tuned by adjusting the annealing temperature and/or the annealing time. For example, in some cases, using a higher annealing temperature in the annealing process can result in an annealed thermoplastic polyurethane material with a higher melting temperature as compared to the thermoplastic polyurethane material annealed at a lower annealing temperature. In some additional examples, using a longer annealing time in the annealing process can also result in an annealed thermoplastic polyurethane material with a higher melting temperature as compared to the thermoplastic polyurethane material annealed for a shorter annealing time. Thus, the processing window of the annealed thermoplastic polyurethane material can be partially tuned based on the annealing temperature and/or annealing time.

The annealing process can be performed in a variety of ways using any suitable equipment, such as in any suitable oven. In some specific examples, a rotating dryer can be employed. In some additional examples, annealing can be performed in a relatively inert atmosphere, such as in a nitrogen atmosphere, an argon atmosphere, or the like.

By employing the methods described herein, an annealed thermoplastic polyurethane material can be prepared that can be suitable for a variety of additive manufacturing processes. For example, as described above, the annealed thermoplastic polyurethane material can have somewhat different melting characteristics as compared to the non-annealed material. For example, in some cases, the annealed thermoplastic polyurethane material can result in a single melting peak based on a DSC analysis from −25° C. to 250° C. at a 20° C./min heating rate. In some examples, the annealed thermoplastic polyurethane material can have fewer melting peaks than the non-annealed material based on a DSC analysis from −25° C. to 250° C. at a 20° C./min heating rate. In still additional examples, the annealed thermoplastic polyurethane material can have a single melting peak or a greatest melting peak (e.g., a main melting peak) having a full width at half maximum (FWHM) value of less than or equal to 15° C. as measured by DSC analysis from −25° C. to 250° C. using a 20° C./min heating ramp. In yet additional examples, the annealed thermoplastic polyurethane material can have a single melting peak or a greatest melting peak (e.g., a main melting peak) having a FWHM value of less than or equal to 12° C., less than or equal to 10° C., less than or equal to 8° C., or less than or equal to 5° C., as measured by DSC analysis from −25° C. to 250° C. using a 20° C./min heating ramp.

In some non-limiting examples, the annealed thermoplastic polyurethane material can have a melting temperature of at least 150° C. as determined by DSC analysis as described herein. In still additional non-limiting examples, the annealed thermoplastic polyurethane material can have a melting temperature of at least 160° C., at least 170° C., at least 180° C., or at least 190° C. as determined by DSC analysis as described herein.

In additional examples, the annealed thermoplastic polyurethane material can have a melting temperature that is no more than 140° C. greater than a crystallization temperature of the non-annealed thermoplastic polyurethane material as determined by DSC analysis as described herein. In still additional examples, the annealed thermoplastic polyurethane material can have a melting temperature that is no more than 130° C. greater, no more than 120° C. greater, no more than 110° C. greater, or no more than 100° C. greater than a crystallization temperature of the non-annealed thermoplastic polyurethane material as determined by DSC analysis as described herein.

In further examples, the annealed thermoplastic polyurethane material can have a melting temperature that is at least 50° C. greater than a crystallization temperature of the annealed thermoplastic polyurethane material as determined by DSC analysis as described herein. In yet further examples, the annealed thermoplastic polyurethane material can have a melting temperature that is at least 60° C., at least 70° C., at least 80° C., at least 90° C., or at least 100° C. greater than a crystallization temperature of the annealed thermoplastic polyurethane material as determined by DSC analysis as described herein.

In additional examples, the annealed thermoplastic polyurethane material can have a melting enthalpy of at least 8 joules per gram (J/g) as determined by DSC analysis as described herein. In still additional examples, the annealed thermoplastic polyurethane material can have a melting enthalpy of at least 10 J/g, at least 12 J/g, at least 14 J/g, at least 16 J/g, at least 18 J/g, or at least 20 J/g as determined by DSC analysis as described herein.

Thus, the annealing process can alter a variety of thermal characteristics of the thermoplastic polyurethane material as compared to the non-annealed thermoplastic polyurethane. Non-limiting examples can include altering the melting temperature of the thermoplastic polyurethane material, altering the number of melting peaks on a DSC plot or curve, altering the FWHM value of one or more peaks on a DSC plot or curve, altering the melting enthalpy of the thermoplastic polyurethane material, etc. as compared to the non-annealed thermoplastic polyurethane as determined by DSC analysis as described herein. In some examples, one or more of these thermal modifications can render the thermoplastic polyurethane material more suitable for one or more additive manufacturing processes as compared to the non-annealed thermoplastic polyurethane material.

As described previously, complete melting of the annealed thermoplastic polyurethane material can effectively erase the thermal modifications achieved by the annealing process and return the thermoplastic polyurethane material to an essentially non-annealed condition. Thus, this is one way to determine whether a thermoplastic material has been annealed as described herein. More specifically, an annealed thermoplastic polyurethane material can have one or more non-permanent thermal modifications to render the material more suitable for one or more additive manufacturing methods. The thermal modifications of the annealed thermoplastic polyurethane material are detectable by DSC analysis. After determining the DSC profile of the annealed thermoplastic polyurethane material, the thermoplastic polyurethane material can be fully melted and once again evaluated using DSC. A comparison of the DSC analyses before and after complete melting of the thermoplastic polyurethane material will show clear differences in the DSC profile. As one non-limiting example, the DSC profile of the annealed thermoplastic polyurethane material prior to melting can show a single melting peak with a FWHM value of less than 10° C., whereas the DSC profile of the previously-annealed thermoplastic polyurethane material after complete melting can exclude the single melting peak with a FWHM value of less than 10° C.

In some additional examples, after annealing the thermoplastic polyurethane material, the annealed thermoplastic polyurethane material can be comminuted to a particle size that is suitable for the intended additive manufacturing process to produce a comminuted annealed thermoplastic polyurethane material. Generally, the annealed thermoplastic polyurethane material can be comminuted to have an average particle size of less than 300 μm, but particles outside of this range may be desirable in some circumstances. In some specific examples, the annealed thermoplastic polyurethane material can be comminuted to an average particle size of from 1 μm to 250 μm. In still additional examples, the annealed thermoplastic polyurethane material can be comminuted to an average particle size of from 1 μm to 50 μm, from 20 μm to 100 μm, from 50 μm to 150 μm, or from 100 μm to 200 μm. As used herein, “particle size” refers to the largest diameter of a particle.

Comminuting can be performed in a variety of ways. Non-limiting examples can include dry milling or grinding in a jet mill, a pin mill, or the like, wet media milling, the like, or a combination thereof. Additionally, in some examples, grinding or milling can be performed under cryogenic conditions to minimize the heat transferred to the annealed thermoplastic polyurethane material during comminuting, which can alter or even erase the thermal effects of the annealing process if temperatures are sufficiently high. As such, in some examples, comminuting can include cryogenic comminuting.

In some examples, the comminuted annealed thermoplastic polyurethane material alone can form a suitable additive manufacturing build material. In some further examples, the comminuted annealed thermoplastic polyurethane material can be combined with or admixed with one or more additional materials or additives to form an additive manufacturing build material. Non-limiting examples of additive manufacturing additives that can be added to the comminuted annealed thermoplastic polyurethane material can include a colorant, an antioxidant, an antiozonant, a stabilizer (e.g., a hydrolysis stabilizer, a light stabilizer, a heat stabilizer, a color stabilizer, etc.), a filler, a lubricant, an inhibitor, a UV absorber, a reinforcing agent, the like, or a combination thereof.

The build material comprising the comminuted annealed thermoplastic polyurethane material can be employed in a variety of additive manufacturing processes to form a 3D printed object. For example, computer aided drafting (CAD) software or other suitable software can be employed to generate a 3D object model. Based on the 3D object model, a 3D article can be printed via a variety of additive manufacturing techniques. In some specific examples, the additive manufacturing technique can be a powder bed fusion technique, such as selective laser sintering (SLS), high speed sintering (HSS) (e.g., multi jet fusion (MJF)), or the like. Other suitable additive manufacturing techniques can also be employed.

### EXAMPLES

In each of the Examples below, DSC analysis was performed using a PerkinElmer DSC8000, heating from −25 to 250° C. at a temperature ramp of 20° C./min. Two alternative annealing conditions were used to treat the thermoplastic polyurethane (TPU) samples. In some examples, TPU samples were held isothermally at a specified temperature in the DSC instrument for 1 to 8 hours and then analyzed by DSC. In other examples, TPU samples were annealed in an oven at a set temperature for 1 to 3 hours and then analyzed by DSC.

Example 1: An aromatic ether-based TPU manufactured by COVESTRO® having a shore hardness of from 75D to 80D and a hard segment content between 65 wt % and 75 wt % based on a total weight of the TPU was employed in this example. Prior to annealing, this TPU exhibited several hard segment melting peaks above 190° C. Annealing increased the enthalpy of melting, increased the melting temperature, and narrowed the melting peak range based on the full width at half maximum (FWHM) value. It was observed that increasing the annealing time and/or temperature increases the melting temperature and narrows the melting peak in the annealed TPU. For example, samples annealed below 190° C. did not result in a single melting peak, but did result in melting peaks at increasingly higher temperatures. Samples heated at or above 190° C. resulted in a single melting peak, with or without a shoulder. As one example, a single melting peak was obtained after annealing at 210° C., and the new melting peak temperature was higher (237° C.) than the annealing temperature. A few samples were cooled and reheated a second time to examine the effect of annealing. After fully melting the annealed samples at 250° C., the effects of annealing were thermally erased. More specifically, after fully melting, the recrystallization temperature (Tₐ) on cooling and the melting temperature (Tₘ) on reheat were very similar to the non-annealed sample. Further, these results indicated no material degradation during the annealing process. These results are presented in Table 1.

TABLE 1
Summary of Results from Example 1

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| First Heat | 190*, 198, 210 | ‡ | 76 | — |
| | (21.59) | | | |
| Reheat after | 189*, 199, 209 | ‡ | 75 | 10 |
| 160° C./4 hr | (31.03) | | | |
| (Comparative | | | | |
| Example) | | | | |
| Reheat after | 192*, 210 | ‡ | 78 | 10 |
| 160° C./8 hr | (32.32) | | | |
| (Comparative | | | | |
| Example) | | | | |
| Reheat after | 201*, 211 | ‡ | 87 | 29 |
| 180° C./1 hr | (28.67) | | | |
| (Comparative | | | | |
| Example) | | | | |
| Reheat after | 208 s, 214* | 7 | 100 | 54 |
| 190° C./1 hr | (30.49) | | | |
| (Inventive | | | | |
| Example) | | | | |
| Reheat after | 222*, 230 s | 7 | 108 | 73 |
| 200° C./1 hr | (32.95) | | | |
| (Inventive | | | | |
| Example) | | | | |
| Reheat after | 237 | 7 | 123 | 95 |
| 210° C./1 hr | (35.98) | | | |
| (Inventive | | | | |
| Example) | | | | |

*main peak in a multiple peak event,
s: shoulder,
Tc = 114° C.
‡: FWHM not calculated due to presence of multiple melting peaks

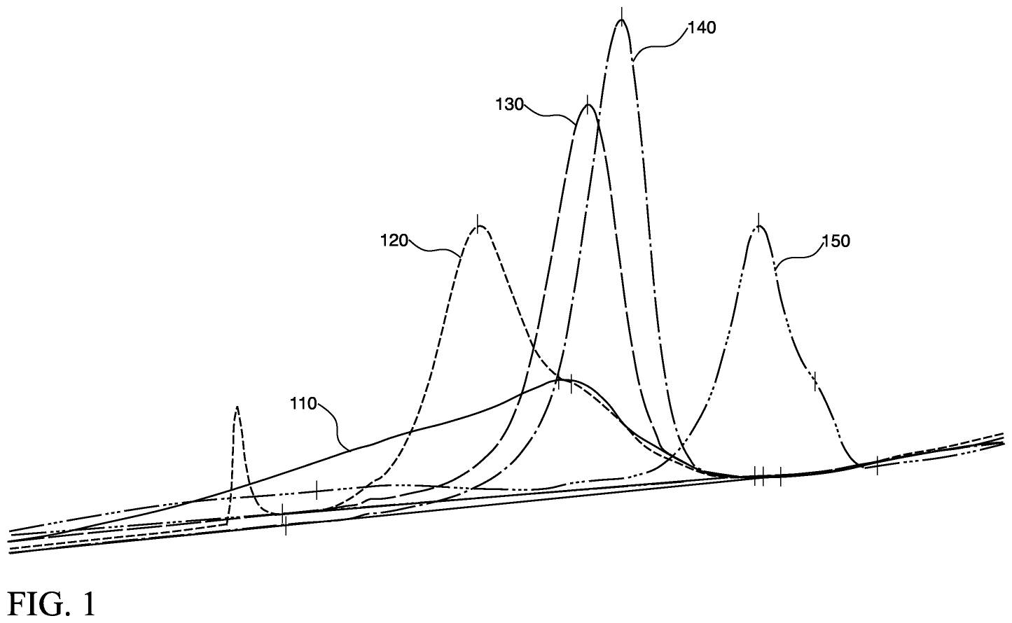

Example 2: An aromatic ether-based TPU manufactured by COVESTRO® having a shore hardness of from 47D to 53D and from 50 wt % to 60 wt % hard segment based on a total weight of the TPU was used in this example. This TPU had a lower melting temperature than the TPU used in Example 1. Optimal annealing was performed below the melting temperature. The results of this study are presented in Table 2 and FIG. 1. Melting data for the non-annealed sample (First Heat) is presented in plot 110, which depicts a broad melting peak for the non-annealed sample. In contrast, plot 120 presents melting data for the TPU annealed at 150° C. for 1 hour, which resulted in a much narrower melting peak at 170° C. with a shoulder. Samples annealed at 160° C. for 1 hour (plot 130) or 2 hours (plot 140) resulted in even narrower single melting peaks at 181° C. and 185° C., respectively. However, annealing the TPU sample slightly above the melting temperature at 180° C. for 1 hour (plot 150) resulted in two melting peaks, where the highest melting peak had a shoulder.

TABLE 2
Summary of Results from Example 2

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| First Heat | 179 | ‡ | 87 | — |
| | (17.96) | | | |
| Reheat after | 170*, 180 s | 10 | 78 | 29 |
| 150° C./1 hr | (14.42) | | | |
| (Inventive | | | | |
| Example) | | | | |
| Reheat after | 181 | 9 | 89 | 42 |
| 160° C./1 hr | (14.04) | | | |
| (Inventive | | | | |
| Example) | | | | |
| Reheat after | 185 | 7 | 93 | 42 |
| 160° C./2 hr | (15.43) | | | |
| (Inventive | | | | |
| Example) | | | | |
| Reheat after | 154, 200*, | ‡ | 108 | 82 |
| 180° C./1 hr | 206 s | | | |
| (Comparative | (11.52) | | | |
| Example) | | | | |

*main peak in a multiple peak event,
s: shoulder,
Tc = 92° C.
‡: FWHM not calculated due to presence of multiple melting peaks

Example 3: An aromatic ester-based TPU manufactured by COVESTRO® having a shore hardness of from 90 A to 95 A and from 40 wt % to 50 wt % hard segment based on a total weight of the TPU was used in this example. This TPU exhibited lower melting hard segment compared to either of the TPUs used in Example 1 or Example 2. Samples annealed at 150° C. resulted in a single melting peak (167-171° C.) and samples annealed at 150-160° C. resulted in a single melting peak (167-178° C.). Annealing at 120° C. or lower did not have significant effect on narrowing the melting peak. Annealing at 175° C. above the original melting peak temperature had a negative effect on the peak width. These results are presented in Table 3.

TABLE 3
Summary of Results from Example 3

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| First Heat | 124, 150, 163* | ‡ | 92 | — |
| | (12.02) | | | |
| Reheat after | 140*, 168 | ‡ | 69 | 24 |
| 120° C./1 hr | (18.64) | | | |
| (Comparative | | | | |
| Example) | | | | |
| Reheat after | 158*, 173 s | 15 | 87 | 41 |
| 140° C./1 hr | (12.46) | | | |
| (Inventive | | | | |
| Example) | | | | |
| Reheat after | 167 | 14 | 96 | 51 |
| 150° C./1 hr | (10.68) | | | |
| (Inventive | | | | |
| Example) | | | | |
| Reheat after | 171 | 10 | 100 | 51 |
| 150° C./2 hr | (11.41) | | | |
| (Inventive | | | | |
| Example) | | | | |
| Reheat after | 178 | 8 | 107 | 67 |
| 160° C./1 hr | (8.74) | | | |
| (Inventive | | | | |
| Example) | | | | |
| Reheat after | 181 | 8 | 110 | 74 |
| 165° C./1 hr | (14.50) | | | |
| (Inventive | | | | |
| Example) | | | | |
| Reheat after | 158*, 192 | ‡ | 87 | 89 |
| 175° C./1 hr | (11.01) | | | |
| (Comparative | | | | |
| Example) | | | | |

*main peak in a multiple peak event,
s: shoulder,
Tc = 71° C.
‡: FWHM not calculated due to presence of multiple melting peaks

Example 4: Effects of annealing and post-annealing conditions of pellets of the TPU used in Example 3 were evaluated using an oven at different temperatures/time periods. When the annealing temperature was increased from 150 to 160° C., the peak melting temperature increased 5-10° C. Smaller increases (2-3° C.) in melting temperature were achieved by increasing the annealing time at 150° C. from 1 hr to 2 and 3 hrs. Annealing the pellets at a much lower temperature of 100° C. (24 hr hold) increased the enthalpy of the melting peak at 126° C. and actually decreased the enthalpy of melting for the melting peak at 168° C.

Using liquid nitrogen (LN₂) to cool the pellets immediately after removing them from an oven at 150° C. did not affect the thermal modifications of annealing. The sample that was aged at 2 weeks at 50° C. had a similar melting peak as the sample that was not aged post-annealing. This suggests that the rate of cooling, as well as heating at temperatures well below the main melting peak, have minimal impact on the thermal modifications of annealing. These results are presented in Table 4.

TABLE 4
Summary of Results from Example 4

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| First Heat | 167*, 175 | ‡ | 96 | — |
| | (23.95) | | | |
| Annealed | 156*, 168 | ‡ | 85 | 1 |
| 100° C./24 hr | (17.26) | | | |
| (Comparative | | | | |
| Example) | | | | |
| Annealed | 163 | 11 | 92 | 41 |
| 150° C./1 hr | (13.93) | | | |
| (Inventive | | | | |
| Example) | | | | |
| Annealed | 165 | 11 | 94 | 41 |
| 150° C./2 hr | (12.27) | | | |
| (Inventive | | | | |
| Example) | | | | |
| Annealed | 168 | 11 | 97 | 41 |
| 150° C./2 hr | (13.41) | | | |
| then LN₂ | | | | |
| quenched | | | | |
| (Inventive | | | | |
| Example) | | | | |
| Annealed | 82, 167* | ‡ | 96 | 41 |
| 150° C./2 hr | (26.54) | | | |
| then aged | | | | |
| 50° C./2 weeks | | | | |
| (Inventive | | | | |
| Example) | | | | |
| Annealed | 166 | 11 | 95 | 41 |
| 150° C./3 hr | (14.00) | | | |
| (Inventive | | | | |
| Example) | | | | |
| Annealed | 173 | 10 | 102 | 63 |
| 160° C./1 hr | (12.93) | | | |
| (Inventive | | | | |
| Example) | | | | |

*main peak in a multiple peak event,
s: shoulder,
Tc = 71° C.
‡: FWHM not calculated due to presence of multiple melting peaks

Example 5: An aromatic ether-based TPU manufactured by COVESTRO® having a shore hardness of from 80 A to 85 A and a hard segment content between 35 wt % and 40 wt % based on a total weight of the TPU was employed in this example. The non-annealed pellets exhibited a melting peak at 156° C. and a broad melt range on first heat. Annealing temperatures were selected at about this melting peak (150° C., 79% HS melting). One of the annealed samples was stored at room temperature for 8 months to determine whether the effects of annealing are stable over time. One additional annealed sample was cryogenically ground and then stored at room temperature for 8 months to determine whether annealing effects would also be stable over time in cryogenically ground powder. As can be seen in Table 5, the annealing effects on the thermoplastic polyurethane material were relatively stable over a period of at least 8 months with or without cryogenic grinding.

TABLE 5
Summary of Results from Example 5

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| First Heat | 104*, 156 | 25 | 42 | — |
| | (24.39) | | | |
| Annealed | 165 | 10 | 103 | 80 |
| 150° C./1 hr | (10.73) | | | |
| (Inventive | | | | |
| Example) | | | | |
| TPU Pellets | 164 | 11 | 102 | 80 |
| Annealed | (4.4) | | | |
| 150° C./1 hr, | | | | |
| Stored at RT | | | | |
| for 8 months | | | | |
| (Inventive | | | | |
| Example) | | | | |
| Cryogenically | 156 | 12.5 | 94 | 80 |
| Ground | (6.4) | | | |
| Powder | | | | |
| Annealed | | | | |
| 150° C./1 hr, | | | | |
| Stored at RT | | | | |
| for 8 months | | | | |
| (Inventive | | | | |
| Example) | | | | |

*main peak in a multiple peak event,
s: shoulder,
Tc = 62° C.
‡: FWHM not calculated due to presence of multiple melting peaks

Comparative Example 1: PA12 resin was purchased from Sigma-Aldrich. Untreated pellets of PA12 exhibited a melting peak at 180° C. The pellets were annealed 10° C. below the peak Tₘ, at the Tₘ, and where 95% of the main peak's crystalline phase was melted. While there was some perfection of the crystalline phase with a melting temperature below the peak melting temperature, the peak melting temperature did not significantly shift. Thus, the annealing process had minimal effect on the PA12 resin. These results are presented in Table 6.

TABLE 6
Summary of Results from Comparative Example 1

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| PA12 - untreated | 47 (2.32), | 7 | 41 | — |
| pellets - | 98 (1.41), | | | |
| first heat | 158 (2.33), | | | |
| | 180 (53.89) | | | |
| PA12 - annealed | 181 | 6 | 42 | 9 |
| 170° C./1 hr | (86.07) | | | |
| PA12 - annealed | 177, 179* | 7 | 40 | 76 |
| 180° C./1 hr | (71.57) | | | |
| PA12 - annealed | 173, 180* | ‡ | 41 | 95 |
| 183° C./1 hr | (69.12) | | | |

*main peak in a multiple peak event,
s: shoulder,
Tc = 139° C.
‡: FWHM not calculated due to presence of multiple melting peaks

Comparative Example 2: Another aromatic ether-based TPU manufactured by COVESTRO® having a shore hardness of from 65 A to 75 A and from 20 wt % to 28 wt % hard segment based on a total weight of the TPU was used in this example. The untreated TPU pellets exhibited a main melting peak at 101° C. on first heat and there was higher melting hard segment component at 152° C. Annealing temperatures were therefore selected at this melting peak and 10° C. above (150° C. and 160° C., 83% HS melting and 91% HS melting, respectively). While there was a significant increase in the peak Tₘ with annealing, there was still considerable melting across a wide temperature range without a narrow melting peak that is desirable for many additive manufacturing techniques. Additionally, the melting enthalpy was greatly reduced to <10 J/g. These results are presented in Table 7.

TABLE 7
Summary of Results from Comparative Example 2

| | Tₘ | | | |
|---|---|---|---|---|
| | (ΔHₘ) ° C. | | Tm (main)- | % melt at |
| Samples | (J/g) | FWHM ° C. | Tc ° C. | anneal T |
| Untreated | 101*, 152 | ‡ | 39 | — |
| TPU Pellets - | (16.85) | | | |
| first heat | | | | |
| Untreated | 111, 171* | ‡ | 109 | 82 |
| TPU Pellets - | (6.89) | | | |
| annealed | | | | |
| 150° C./1 hr | | | | |
| Untreated | 115 (5.87) | ‡ | 118 | 90 |
| TPU Pellets - | 180 (1.06) | | | |
| annealed | | | | |
| 160° C./1 hr | | | | |

*main peak in a multiple peak event,
s: shoulder,
Tc = 62° C.
‡: FWHM not calculated due to presence of multiple melting peaks

It should be understood that the above-described methods are only illustrative of some embodiments of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that variations including, may be made without departing from the principles and concepts set forth herein.

What is claimed is:

1. An annealed thermoplastic material, comprising:
a thermoplastic polyurethane material having a hard segment content of at least 30 wt % based on a total weight of the thermoplastic polyurethane material, wherein the thermoplastic polyurethane material is pre-annealed to have a single melting peak having a full-width at half maximum value of less than or equal to 15° C. based on a differential scanning calorimetry analysis from −25° C. to 250° C. at a 20° C./min temperature ramp, and wherein the thermoplastic polyurethane material does not have a single melting peak having a full-width at half maximum value of less than or equal to 15° C. based on a differential scanning calorimetry analysis from −25° C. to 250° C. at a 20° C./min temperature ramp prior to annealing.

2. The annealed thermoplastic material of claim 1, wherein the annealed thermoplastic polyurethane material has a hard segment content of from 30 wt % to 80 wt % based on a total weight of the annealed thermoplastic polyurethane material.

3. The annealed thermoplastic material of claim 1, wherein the annealed thermoplastic polyurethane material has a shore hardness of from 80 A to 80D based on ASTM D2240-15.

4. The annealed thermoplastic material of claim 1, wherein the annealed thermoplastic polyurethane material has a weight average molecular weight of from 30 kg/mol to 150 kg/mol based on gel permeation chromatography.

5. The annealed thermoplastic material of claim 1, wherein the annealed thermoplastic material has a melting enthalpy of at least 8 J/g.

6. The annealed thermoplastic material of claim 1, wherein the single melting peak has a full-width at half maximum value of less than or equal to 12° C.

7. The annealed thermoplastic material of claim 1, wherein the annealed thermoplastic polyurethane material has a melting temperature of at least 150° C. based on a differential scanning calorimetry analysis from −25° C. to 250° C. at a 20° C./min temperature ramp.

8. The annealed thermoplastic material of claim 1, wherein the annealed thermoplastic polyurethane material has a melting temperature that is no more than 140° C. greater than a crystallization temperature of a corresponding non-annealed thermoplastic polyurethane material based on a differential scanning calorimetry analysis from −25° C. to 250° C. at a 20° C./min temperature ramp.

9. The annealed thermoplastic material of claim 1, wherein the annealed thermoplastic polyurethane material has a melting temperature that is at least 50° C. greater than a crystallization temperature of the annealed thermoplastic polyurethane material based on a differential scanning calorimetry analysis from −25° C. to 250° C. at a 20° C./min temperature ramp.

10. The annealed thermoplastic material of claim 1, wherein the annealed thermoplastic polyurethane material comprises a reaction product of:
an aromatic polyisocyanate,
a chain extender having a number average molecular weight of from 60 g/mol to 450 g/mol, and
a soft segment component having functional groups that are reactive toward isocyanate groups.

11. The annealed thermoplastic material of claim 1, further comprising a colorant, an antioxidant, an antiozonant, a stabilizer, a filler, a lubricant, an inhibitor, a UV absorber, a reinforcing agent.

12. The annealed thermoplastic material of claim 1, wherein the annealed thermoplastic material is a comminuted to form a pulverulent annealed thermoplastic material having a particle size of less than 300 μm.

13. A three-dimensional (3D) printed article, comprising:
a thermoplastic pulverulent material according to claim 1 fused together based on a 3D object model.

14. A method of manufacturing an annealed thermoplastic polyurethane material, comprising:
annealing a thermoplastic polyurethane material to form an annealed thermoplastic polyurethane material

15. The method of claim 14, wherein annealing comprises heating the thermoplastic polyurethane material to an annealing temperature of from 40° C. less than a pre-annealing melting temperature to 5° C. greater than the pre-annealing melting temperature for an annealing period.

16. The method of claim 14, wherein annealing is performed in a rotating dryer under an inert atmosphere

17. The method of claim 14, wherein annealing comprises heating the thermoplastic polyurethane material until from 25% to 85% of the hard segment is melted.

18. The method of claim 17, further comprising comminuting the annealed thermoplastic polyurethane material to a particle size of less than 300 μm.

19. The method of claim 14, wherein comminuting comprises cryogenic milling.
